(19) United States
(12) Patent Application Publication
(10) Pub. No.: US 2010/0267361 A1
(43) Pub. Date: Oct. 21, 2010

(54) MONITORING DEVICE AND SYSTEM

(75) Inventor: Jason Sullivan, Tampa, FL (US)

Correspondence Address: CHRISTOPHER PARADIES, PH.D., FOWLER WHITE BOGGS P.A., 501 E KENNEDY BLVD, STE. 1700, TAMPA, FL, 33602, US

(73) Assignee: GuardianLion Wireless, LLC, Tampa, FL (US)

(21) Appl. No.: 12/728,591

(22) Filed: Mar. 22, 2010

Related U.S. Application Data
(60) Provisional application No. 61/162,211, filed on Mar. 20, 2009.

(51) Int. Cl. H04W 4/22; G01S 19/42

(52) U.S. Cl. 455/404.2; 342/357.25

(57) ABSTRACT

A monitoring device and system capable of tracking, monitoring and locating a person allows a parent, guardian or supervisor to set inclusive and exclusive limits, permanently or temporally. The device includes a GPS receiver and a cellphone integrated into a band capable of being locked on a limb of person to be monitored. A child armband may have antitamper devices included in the band that prevents its removal and automatically sends alerts if the band is removed. An alert may be initiated and delivered by the system when the device leaves a temporal inclusion zone or when the device strays into an exclusion zone. The device may have an alarm capable of being activated by an authorized agent at a time when the authorities are within ear shot of the alarm. The antennas may be housed within cavities in the band and the electronics for the GPS receiver and wireless communication device may be contained within tamper resistant housing.

### RELATED APPLICATION

This application claims the benefit of U.S. Provisional Patent Application 61/162,211, filed Mar. 20, 2009, the disclosure of which is hereby incorporated by reference.

### FIELD OF THE INVENTION

The field is the technology of protective tracking devices.

### BACKGROUND

Devices are known for monitoring the location and adherence to stipulated home confinement of certain detainees. However, these devices require a party to be within the range of a telephone and have a limited range and functionality. Such devices are not suitable for tracking the location of a child or providing an alert if a child is in danger or enters a zone outside of a permitted zone or within an excluded zone. Other devices are known that use GPS signals for tracking, but these signals are often blocked from detection of signals from overhead satellites by structures, terrain and vegetation. Cellphones are known that combine a GPS tracking capability and cellphone tracking, but cellphones are easily separated from a child by accident or intentionally.

Emergency alert devices are known that provide the wearer the ability to press a panic button. These devices have no other function then to relay a call to a service, which can bring help to the person's location if needed.

Cellular technology is known that allows a user to make a telephone call to a limited number of individuals. However, cellular technology is not integrated with a service that provides assistance when called. Also, cell phones are known that include a GPS tracking device; however, these devices are normally off. The user must initiate the GPS tracking and mapping routines on the cellular telephone. Continuous tracking and mapping greatly reduces battery life of a cellular device.

Services are available for use with a vehicle mounted device for tracking the location and condition of an automobile, allowing two-way communication with the occupants of the vehicle. However, these devices are only capable of use in a vehicle, and the service is provided only when the service is alerted to an accident by the vehicles safety equipment or when contacted by the occupant or authorities.

### SUMMARY

A device and system for protection of a child includes a combination of features that safeguard a child and make it possible for parents or authorities to track and find a child. For example, a device may include a GPS locator, a locking adjustable strap, and a communication device. The system includes software or firmware on the device and external software or firmware that provides for interaction with the device, such as voice communication, setting geographic alert limits, and location tracking. The system may be used to track the location of the device and to send alerts, whenever the device strays from an alert area, region or path. When, the device enters a restricted area or strays from a permitted area, the device may send a silent alert to a service that follows an alert protocol. The alert protocol may first contact a parent or guardian, for example.

A device for locating, tracking or monitoring a person, comprising: a global positioning system (GPS) receiver, a wireless telephone communicator, a housing enclosing at least a portion of the electronic components of the GPS receiver, and at least a portion of the electronic components of the wireless telephone communicator, a band coupled to the housing, wherein the strap is adjustable and includes a locking mechanism for preventing removal of the device from a limb of the person without an unlocking mechanism, an alert system, and an electronic operating system including an interface to the alert system, such that the alert system communicates using the wireless telephone communicator and the GPS receiver to send a panic alert message to an emergency receiver instructing the emergency receiver of the location of the device. The band may include one or more cavities for housing an antenna for the GPS receiver, the wireless telephone communicator or both the GPS receiver and the wireless telephone communicator. The band may include an antitamper alert system capable of tripping the alert system and to prevent cutting of the band. A pair of actuators may be provided that are electronically coupled with an alert system such that, when the pair of actuators are activated at the same time, the alert system is activated.

The system may communicate using the wireless telephone communicator and the GPS receiver to send a panic alert message to an emergency receiver instructing the emergency receiver of the location of the device. The location of the device is updated periodically or continually when the alert system is activated. A GPS receiver may be used to send a panic alert message to an emergency receiver within the vicinity of the GPS receiver, wherein an emergency responder, a monitoring agency, a parent, a guardian and/or supervisor may be notified of the location of the device periodically when the alert system is activated. For example, the electronic operating system includes a monitoring and tracking mode, wherein the monitoring and tracking mode activates the alert system when the device exceeds a threshold speed for a threshold time period, when the device enters a geographically defined exclusion zone during a defined exclusion time, when the device strays from a geographically defined inclusion zone during a defined inclusion time, or a combination of thereof, and the alert system notifies a receiver other than the emergency receiver. The electronic operating system may activate the wireless telephone communicator to transmit sound over the wireless telephone communicator to the receiver other than the emergency receiver, such that the receiver, such as a parent's cellphone, can hear sound in the vicinity of the device over the wireless communicating device in a child safety device, for example. The electronic operating system activates the GPS receiver and transmits the location of the device to the receiver.

The wireless telephone communicator or the electronic operating system is capable of accessing a plurality of telephone numbers stored in a digital storage medium for connecting the wireless telephone communicator with one or more of the plurality of telephone numbers. The wireless telephone communicator or the electronic operating system are coupled to a user interface capable of selecting one or more of the plurality of telephone numbers. A digital storage medium and the GPS receiver may be capable of storing data to the digital storage medium. Data stored by the GPS receiver may include a location of the device as determined by the GPS receiver. The data storage medium is capable of storing a plurality of locations of the device as determined by the GPS receiver, and the electronic operating system controls the storing of data using the digital storage medium.

A shock sensor or accelerometer may be operably coupled to the electronic operating system, which may be monitored to alert the system of tampering or removal of a child protective device, for example. A panic alarm may be coupled with the electronic operating system. The electronic operating system trips the panic alarm, which may emit an audible sound, and the audible sound may be only activated when an authorized agent activates the panic alarm.

This may be used to activate the alarm only when authorities or rescuers are within ear shot of the alarm. An immersion sensor may be coupled with the electronic operating system. The alert system of the device is capable of interfacing with the Amber alert system such that the Amber alert system is capable of notifying the public in the vicinity of the device in one example.

An anti-cutting reinforcement may include titanium ribbon, strands or cable, or it may include steel strands spun around a core of aramid fibers, for example. The anti-cutting reinforcement may include a trip sensor line that notifies the electronic operating system of an open circuit if the trip sensor line is cut, such as at least one electrically conductive wire or at least one optical fiber.

An accelerometer may be coupled to the electronic operating system and may be monitored by the electronic operating system, and the electronic operating system may determine if the device is motionless for a threshold time period for tripping a fault alert. For example, the fault alert commences a fault detection system by the electronic operating system to determine if the device is malfunctioning or has been removed from the person.

A system for monitoring, tracking and locating a child using the device of claim 1 may comprise a computer capable of being wirelessly coupled to such a device, the computer system including a data storage device, a display and an input device. A program may be stored in the data storage device that is capable of monitoring, tracking and locating the child. And the program may be capable of graphically displaying the location of the child. The program may be capable of receiving input from the input device to register temporal exclusion and inclusion zones with the device, and the device can notify the system when it strays into an exclusion zone or out of an inclusion zone during a time when the zones are active (i.e. temporally). The program, the input device and the display may be integrated into a graphical user interface of the computer and may be capable of displaying a map on the display. The input device may be capable of selecting temporal exclusion and inclusion zones, for example, or other alert conditions, such as threshold speed. For example, the system may be notified by the device when the device exceeds the threshold speed.

The computer may be alerted when the alert system of the device is activated. The system may alert a receiver, when the alert system of the device is activated, such as a cellphone, computer, telephone or other communication device for contacting a responsible person(s). In some examples, an emergency response system may be automatically alerted, when the alert system enters a panic mode.

### BRIEF DESCRIPTION OF THE DRAWINGS

FIG. 1 illustrates a perspective view of a protective device.

FIG. 2 illustrates a perspective view of the device in FIG. 1 mounted on a child's wrist.

FIG. 3 illustrates a side view of the device of FIG. 1.

FIG. 4 illustrates an end view of the device of FIG. 1.

FIG. 5 illustrates a top view of the device of FIG. 1.

FIG. 6 illustrates a schematic view of the internal components a device such as the device of FIG. 1.

FIG. 7 illustrates some features of one example of a device such as the device of FIG. 1.

### DETAILED DESCRIPTION

In one example, exclusion and inclusion areas may be defined on a map using a computer, terminal or the like. Then, the exclusion and inclusion areas are downloaded to a wearable device. For example, the wearable device may be a bracelet, such as an arm band or ankle bracelet. Preferably, the arm band includes a watch and functions as a cell phone. In one example, the cell phone has a limited number of preprogrammed telephone numbers that the individual may call by pressing buttons on the face of the watch, such as less than 50 programmable numbers. The number of programmable numbers may be limited by a parent or guardian, for example. In one example, a call may be made by pressing only one button on the face of the watch. A plurality of buttons 93 on a watch may call a plurality of different telephone numbers, such as three numbers, or arrow keys, a track ball or other scrolling device may be used to scroll through a list of telephone numbers or names associated with telephone numbers and to commence and end processes, such as initiating a call or terminating a call. In another example, additional buttons 94 may be provided on a device such as a button for beginning 28 and a button for ending 29 a telephone call, sending an emergency alert, and for other functions. For example, a panic button system may be provided on the device. The panic system may include two buttons 17 that must be pressed simultaneous in order to activate a panic alert system.

The system may include alerts for exceeding a certain speed and/or geographic boundary alerts and/or drowning alerts and/or alerts for the presence of alcohol and/or drugs. Thus, the system may monitor a child's safety. Using an alert's menu, a parent may activate certain alerts based on a specified speed limit, such as 15 mph for a child walking or 65 mph for a child driving. In one example, a parent may set up geographic and temporal boundaries using a mapping system that allows polygonal boundaries to be established by the parent. In one system, the system monitors the location of a wearer during a period of time and automatically recommends temporal geographic limits and/or speed limits based on a historical record obtained from information transmitted by a device worn by a child. In addition, certain boundaries may be established by the system using information obtained from external databases, such as child predator databases that show the location or residences of known child predators. For example, a parent may be permitted to activate or deactivate child predator exclusion zones around each residence of a known child predator, which automatically activate and alert, if the device enters any of the excluded child predator zones. An inclusion zone may be defined for a child during certain times of the day, such as boundaries of a school yard during a school day, boundaries of a home and yard during a time that the child is at home, and walking, biking, or bus routes for a time that a child is traveling from one location to another.

Likewise exclusion zones may be set up by a parent or guardian. For example, the parent may set up an exclusion zone for a pool, a pond, a lake, a construction zone, or any other hazard that might present a danger to a child. Inclusion and exclusion zones may be permanent, which provides an alert whenever the child might enter the exclusion zone, may be turned on and off to allow a child to enter an exclusion zone only when permitted by a parent, or may be temporal zones that provide an alert if the child enters the exclusion zone during an exclusion period. Any combination of permanent, permission, and temporal exclusion or inclusion may be set by the parent or other party monitoring the wearer of the device. In one example, up to 3 inclusion zones may be established simultaneously. When one inclusion zone expires, a new inclusion zone may be established. One inclusion zone may overlap temporally and/or geographically with a second inclusion zone, allowing for the movement of the child from one temporal and geographic inclusion zone to another.

Other applications for such a device may be made for monitoring the location of individuals on bail, home detention, work release, and other supervised release. The device may have a locking adjustable arm band, for example, which prevents its removal by the wearer. Alternatively or in addition to locking, the arm band may have a sensor, such as a temperature sensor, electrical sensor or open circuit sensor that determines when the arm band has been removed or is being removed in order to provide an alert to a monitoring service and/or a third party, such as a parent. In one example, a locking arm band is provided with a sensor for determining when the arm band is being cut by a cutting instrument. For example, an electric wire, a fiber optic signal or a combination of these may be inserted in one or more locations of the arm band, such that any cutting of the arm band interrupts the continuity of the wire and/or fiber optic signal. In this case, the system may enter a panic mode that immediately contacts a monitoring service and forwards a request for assistance to the appropriate authorities. One advantage of such a system is that contact may be made simultaneously with the authorities and a child's parent, for example. Likewise, the initiation of a panic mode by the wearer may also initiate an automatic response that initiates a call to the appropriate authority. In one example, the system uses the GPS tracking locator to determine the appropriate 911 call center and initiates a call on the 911 centers ten digit phone number for alerting the appropriate authorities to respond to the alert.

Alternatively, an alert based on exceeding a given speed or geographic boundary may not trigger an immediate alert to the authorities. Instead, an alert may be sent to a third party, such as a parent, monitoring the location of the wearer, such as a child. One advantage of integrating a cell phone into the device is that the third party, such as a parent, or a monitoring service may initiate contact with the wearer to determine why the wearer is exceeding a defined speed limit or is straying across a geographic boundary. Another advantage is that the monitoring system may track in real time the location of the wearer. If the parent or monitoring service is not satisfied with the reason that is given, then authorities may be contacted at the school, day care or emergency services, in order to verify the safety of the wearer. In one example, the initiation of an alert opens the voice communications and records any communications made by the wearer after the tripping of an alert, activation of a panic mode, or indication of cutting of a secure wrist band. In one example, the device may have a panic alarm that may be sounded by the wearer, the monitoring service and/or a third party, such as a parent. In one scenario, the panic alarm may be sounded only when the appropriate authorities are within a distance that could hear the panic alarm. Thus, the panic alarm may be used to locate the device and to protect the wearer at the appropriate time. In one example, the system allows the monitoring service to stay on the line and direct emergency services to the location of the device. In another example, the authorities may be provided with digital information from a monitoring server that may provide a graphical user interface for a first responder. For example, the system may interface with a terminal located in a police cruiser or a hand held device used by a first responder.

In one example, the device may include an immersion, temperature and/or smoke sensor 99 which may be used to alert both the wearer and emergency services of a fire or the like. In one example, the device is waterproof or water resistant, and the device may include an immersion sensor that initiates an alert if the device is immersed under water during a period of time when the software excludes use of the device during swimming or bathing. Thus, the device may be used to alert a parent, guardian, baby sitter, or the monitoring service of a potential drowning hazard. An alarm may be sounded or contact may be made over a cellular device integrated into the device.

In one example, the device saves one or more of the past valid locates of the GPS locator. Thus, the device may be used to indicate the last known location of the wearer of the device if signal is lost with the device for an extended period, which extended period may be set by software or the third party monitoring the location of the device.

In one example, the system is integrated with the amber alert system, such that the authorities may notify the public of a missing or exploited child within a zone of the monitoring device. In another example, the system outputs specific information about the location and situation of the wearer of a device on an emergency website, and third parties may be given secure access to the emergency website. For example, dispatchers, the amber alert system, police and firefighters may be given access to a secure website as needed to provide a sitrep, such as a sitrep including graphics, a recent photograph of the wearer, information and graphical mapping of the location of the wearer. The website used for displaying the sitrep may be secured using SSL or other safeguards to prevent data from being distributed in the clear and may be accessed using a unique userid and password assigned by a service to a third party needing access to the sitrep.

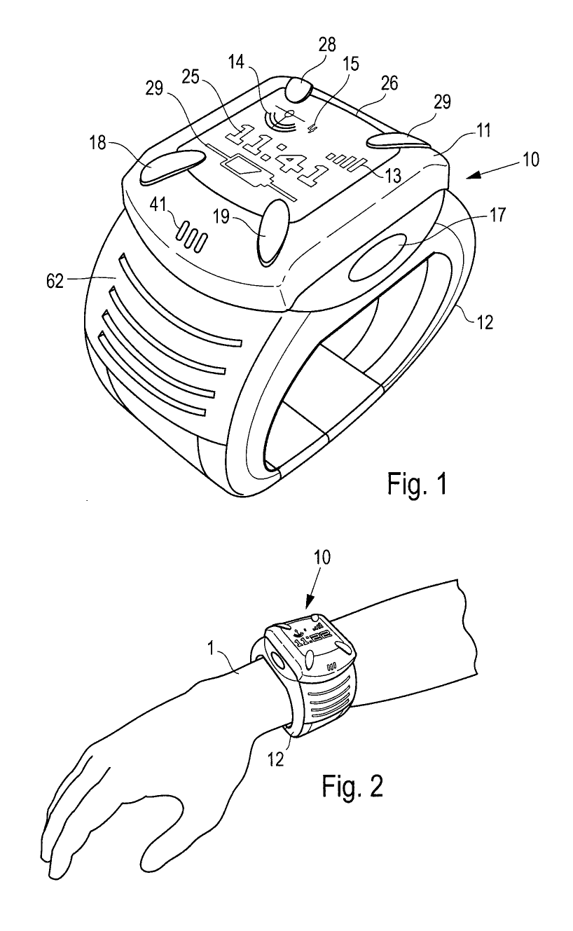

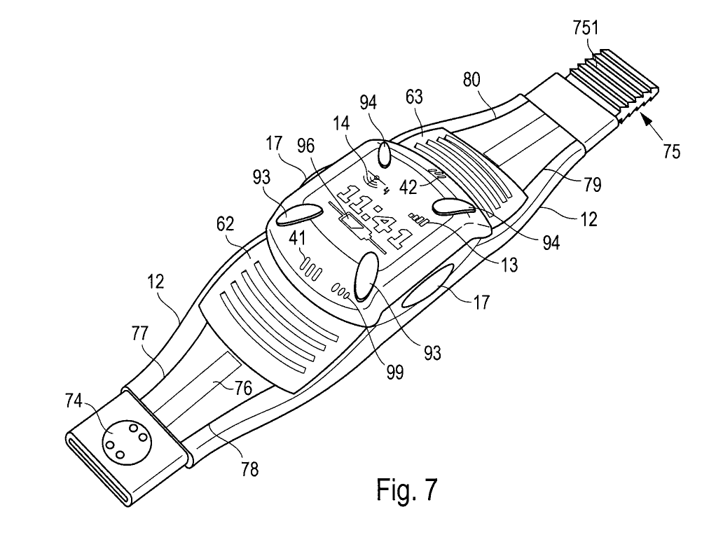

The device 10 in FIG. 1 is a protective device integrating a GPS locator, cellular telephone technology for contacting a monitoring service and programmable numbers. In one example, up to 50 telephone numbers may be programmed into the device 10. A pair of panic buttons 17 are disposed on each side of the device 10, which must be activated simultaneously in order to activate a panic mode, for example. In one example, the panic buttons 17 must be held down simultaneously for one or more seconds to initiate the panic mode, reducing the chance of an inadvertent alert. Avoiding inadvertant alerts may be desireable, if the panic mode initiates a response that automatically notifies the appropriate authorities within a 911 calling area of the device of an immediate need to assist the wearer of the device. A monitoring service may provide the location of the wearer to the authorities or may provide access to additional information, such as identity, photographs and maps of the location of the wearer, using a secure, emergency website or by transmitting text and/or images, such as photographs and maps, to an emergency dispatcher, police or firefighters. The armband 12, which may also be an ankle bracelet, is adjustable and includes a locking mechanism 74, such as illustrated in FIG. 7, for example. The opposite end of the armband 12 has a plurality of raised locking members 751 forming a zip-strip-type ratchet locking member 75, for example. When inserted into the locking mechanism 74 the ratchet locking member 75 is not removable without releasing the raised locking members 751 from one or more latching members that provide a latching mechanism that engages the locking members 751. The locking mechanism 74 may be operated using a key, for example. Alternatively, the locking mechanism 74 may be activated to disengage the latching members remotely by a digital command over a wireless network, such as the cellular network. Alternatively, the locking mechanism 74 may be activated using biometric data, such as a scan of a thumb print, or a combination of these may be used for unlocking the armband 12 of the device 10.

The armband 12 illustrated in FIG. 7 includes anti-cutting reinforcement 76, such as a cable or ribbon made of aramid fibers and steel strands. Steel strands may be spun around the core of the aramid fibers, for example. In addition, anti-cutting detection may be provided by one or more trip sensor wires 77, 78, 79, 80. Trip sensor wires 77, 78, 79, 80 may be optical fibers or electric wires and the like, which initiate a panic mode if one or more of a plurality of the wires, fibers or the like are severed. For example, an optical fiber may be monitored by periodic pulses of light. If the light fails to reach a detector, then the optical fiber is presumed to be severed. An electric wire may initiate an alert if the wires 77, 78, 79, 80 which forms a closed loop between wires 77, 78 on one side of the band 12 and a second closed loop between wires 79, 80 on the opposite side of the armband 12, for example. An immediate alert may be activated to determine if the wearer is safe, for example.

The device 10 shown in FIG. 1 includes digital storage for one or more past, valid locates of a GPS locator disposed within the device 10, which may be sent to a monitoring service over a cellular network, for example. The antenna 61 of the GPS locator, which is schematically represented in FIG. 6, may be disposed in a housing enclosing the GPS antenna within a cavity of the housing in a portion 62 of the armband 12. On the opposite side of the armband 12 another portion of the armband 63 may contain a second antenna cavity for the cellular antenna 63, schematically represented in FIG. 6. Surprisingly, by separating the antennas into opposite sides of the armband 12 both the form factor and the operability of the two antennas are improved compared to other devices, such as cellphones. The device 10 may store exclusion and inclusion zone parameters which may be updated over time based on input from a monitoring system.

Temporal exclusion and inclusion zones may be input using a graphical user interface by a parent or guardian interacting with a mapping overlay system on a website, for example, and the temporal exclusion and inclusion zones may be transmitted to the device when connected to a base station and/or wirelessly, such as via the cellular network. A temporal zone may define not only a geographic boundary but a time associated with the geographic boundary. For example, no alert will be initiated when a child is located within an inclusion zone during a particular time when the inclusion zone is active, but an alert may be initiated if a child is located within the same inclusion zone during a time when the inclusion zone is expired or inactive. In one example, an alert may be initiated even when the device is located in an active inclusion zone, if an accelerometer chip integrated on a printed circuit board 67, which is schematically represented in FIG. 6, detects a lack of movement of the device 10 for a time period greater than an accelerometer threshold alert period. Not all alerts necessarily activate the same protocol. In the case of an alert initiated by an accelerometer, the device 10 may initiate a diagnostic mode to determine if the accelerometer is functioning properly before alerting a monitoring service or a third party.

The monitoring system may include a map that allows a person having a user ID and password authentication to enter a setup mode. The setup mode may be used to select alert conditions for the device. The alert conditions may include speed alerts, which provide an alert when the speed exceeds an entered maximum speed. The programmable alerts may include exclusion and inclusion zones such that leaving an inclusion zone activates an alert or entering an exclusion zone activates an alert. The inclusion and exclusion zones may be established by the monitoring service and activated by a parent or guardian permanently, such as child predator locations, activated on call, such as pools and other areas that are only authorized while under supervision, or temporally, such as based on a school day calendar schedule or the like. In addition, the system may include a mapping algorithm that permits the parent to define polygonal zones of exclusion and inclusion, such as mapping the boundary of a residence, neighborhood, walking route, school yard or the like.

The device shown in FIG. 1 may include sensors. The sensors may include a submersion sensor for detecting submersion in water, a temperature sensor for determining if the device is located on the user's wrist and/or for detecting excessive temperatures associated with being left in a standing vehicle or in a burning building and/or an accelerometer to determine if the appendage of the wearer is in motion or still. Sensors may also include a smoke sensor for alerting the wearer and/or the parent and/or the monitoring service of the presence of smoke. The sensors may also include a detector for trace amounts of alcohol and/or drugs in the presence of a child. In one example, the sensors included in the device may be optional upgrades to the device. In another example, the sensors may be activated or deactivated under software or firmware control using a system for interfacing with the device.

The monitoring system may include automatic forwarding using a ten digit phone number for calling the appropriate 911 call center where the device is physically located. When a panic mode is entered either automatically by cutting of the wrist band or by activation of the wearer or upon confirmation by the monitoring center or parent due to an alert condition other than a panic mode, the location sent by the integrated GPS locating device is correlated by the system to a specific 911 call center. Then, the 911 call center's ten digit phone number is automatically dialed and the monitoring system interfaces with the 911 call center to take the appropriate action to dispatch a first responder.

In one example, the device periodically updates the monitoring system regarding the location of the device. For example, the device may store a plurality of the most recent valid locates, such as 10-15 valid locates, and when the number of valid locates is at or exceeds the capacity of the device to store additional valid locates, then the device may communicate with the monitoring service to transfer the stored values to the monitoring service. Then, the stored valid locates may be overwritten by new valid locates. In one example, if a valid locate is within a specific distance of a previous valid locate, then the valid locate is not stored in its entirety, but a flag is set that shows that the device has remained in the same geographic location. Thus, the period between transfers to the monitoring service may be extended and the battery life of the device prolonged.

In an alternative example, not all of the valid locates are updated to the monitoring service. For example, the monitoring service may only store valid locates when the device is at or near a geographic or other alert boundary. Alert boundaries may include speed, geography, temporal geography or the like. Thus, battery life may be greatly extended by only activating communications when an alert condition is likely to be activated or is actually activated. In yet another example, a combination of periodic updates of the location of the device and more frequent updates of the location of the device may be combined using an artificial intelligence system. The artificial intelligence system may be used to identify routine operation of the device and to activate more frequent updates of the monitoring system, when the device departs from a routine pattern. Thus, battery use and tracking of a device may be optimized by the artificial intelligence system. In one example of the system, the system may be initialized with use in a theme park. The device may be affixed to a child's wrist upon entry of a theme park and may be monitored during activities in the theme park, allowing safety personnel and parents the peace of mind of tracking and mapping the location and safety of a child. For example, if the child is removed from the theme park a panic mode may be entered. Alternatively, the child and parent may each have a wrist band, and if the child strays too far from the parent, then an alert may be sent to the parent's device and/or cellular telephone. If the parent cannot locate the child, then safety personnel may be alerted to assist with the location of the child, using the GPS locator integrated in the child's device.

A digital watch readout 25 may be integrated into a display 26 of the device 10 of FIG. 1, as shown, such as an LCD or organic LED display. Alternatively, or in addition to a watch 25, various face plates or graphical elements may be used to personalize a device. In one example, the display 26 shows a still or animated graphic that may be customized by the wearer or the parent or guardian of the wearer. For example, the child's favorite characters, such as Hannah Montana or SpongeBob SquarePants or Disney characters may be included on the device. Also, face plates 11 may be interchangeable allowing the same device to be worn with different motifs. Additional graphical elements that may be displayed are a battery/charge indicator 29, a cellular network strength indicator 13, and a GPS satellite indicator 14 with an number 15 representing the number of satellites in contact with the GPS system of the device 10. In one example, the device 10 may automatically transmits one or more of the last GPS locations of the device 10 if the cellular signal drops below a certain threshold, the GPS signal is blocked for a threshold time, or the battery/charge drops below a certain level. This leaves a location (most current data point) and trajectory, such as determined from the last ten GPS locations or the last ten minutes of locates from the device, for example.

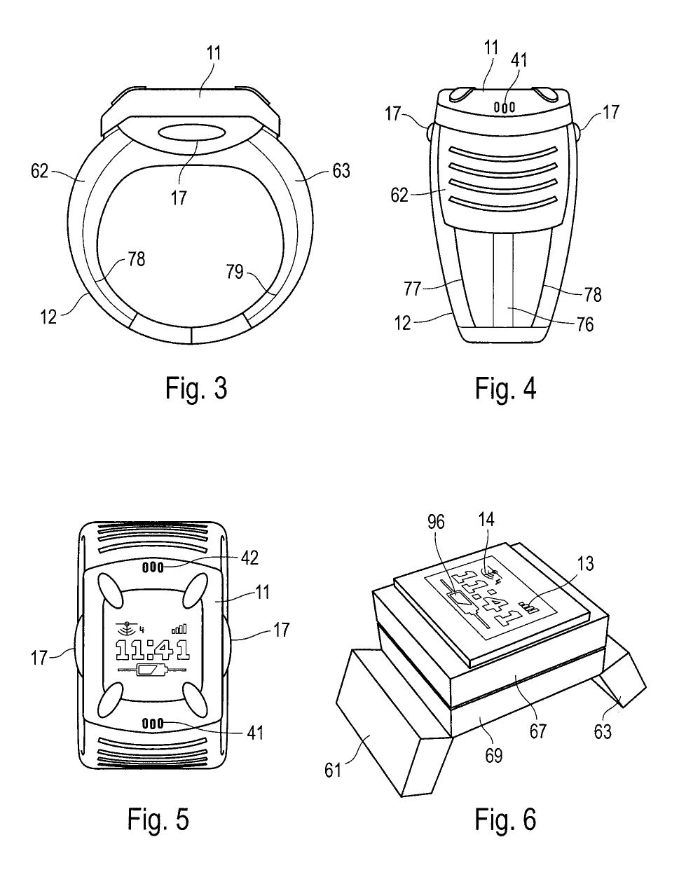

FIG. 2 illustrates the device 10 mounted on the arm 1 of a child using the armband 12. FIG. 3 illustrates a side view of the device 10 showing one of the pair of panic buttons 17. FIG. 4 illustrates an end view of the device 10 showing the portion 62 of the armband 12 that contains the GPS antenna and the microphone 41 and speaker 42 of the cellphone incorporated into the device 10. FIG. 5 illustrates a top view showing a face of a display, for example. While the face of the display in FIG. 5 is functional, the display may include ornamental designs and licensed graphical elements to provide a customized look for each wearer. By incorporating compelling design elements into the display and bezel 11, the device 10 is more readily accepted by the wearer as a desirable accessory. The cables 76 and lines 77, 78 may be wrapped around and through the protective shell of the device, preventing tampering. In one example, the anti-cutting line 77, 78 is an optical fiber or optical fibers included within a bundle of aramid fibers of an anti-cutting cable. Thus, the optical fiber(s) is fully protected from damage caused by routine wear and tear.

A charging device (not shown) may be used to charge the device 10. The charging device may be a battery charger, an adapter having a wall plug on one end, an adapter plug on the other end and a transformer and/or rectifier and/or solid state circuitry for converting the power from the wall outlet to power for charging a rechargeable battery 69, which is schematically represented in FIG. 6. In one example, the rechargeable battery 69 is charged using inductive coupling. In another example, static electric charging is used, at least in part, to charge the rechargeable battery 69. A battery indicator 96 may be displayed on the device.

Combinations and variations of the features present in the examples of the device and system are disclosed. All of the variations and combinations of the features are included within the scope of the present inventions, and the present inventions are not to be limited only to the features of the specific examples described and shown in the drawings.

What is claimed is:

1. A device for locating, tracking or monitoring a person, comprising:
a global positioning system (GPS) receiver;
a wireless telephone communicator;
a housing enclosing at least a portion of the electronic components of the GPS receiver, and at least a portion of the electronic components of the wireless telephone communicator;
a band coupled to the housing, wherein the strap is adjustable and includes a locking mechanism for preventing removal of the device from a limb of the person without an unlocking mechanism;
an alert system; and
an electronic operating system including an interface to the alert system, such that the alert system communicates using the wireless telephone communicator and the GPS receiver to send a panic alert message to an emergency receiver instructing the emergency receiver of the location of the device.

2. The device of claim 1, wherein the band includes a cavity housing an antenna for the GPS receiver, the wireless telephone communicator or both the GPS receiver and the wireless telephone communicator.

3. The device of claim 1, wherein the band includes an antitamper alert system capable of tripping the alert system.

4. The device of claim 3, further comprising a pair of actuators.

5. The device of claim 4, wherein the pair of actuators are electronically coupled with the alert system such that, when the pair of actuators are activated at the same time, the alert system is activated and communicates using the wireless telephone communicator and the GPS receiver to send a panic alert message to an emergency receiver instructing the emergency receiver of the location of the device.

6. The device of claim 5, wherein the location of the device is updated periodically when the alert system is activated.

7. The device of claim 1, further comprising a pair of actuators.

8. The device of claim 7, wherein the pair of actuators are electronically coupled with the alert system such that, when the pair of actuators are activated at the same time, the alert system is activated and communicates using the wireless telephone communicator and the GPS receiver to send a panic alert message to an emergency receiver instructing the emergency receiver of the location of the device.

9. The device of claim 8, wherein the location of the device is updated periodically when the alert system is activated.

10. The device of claim 1, wherein the electronic operating system includes a monitoring and tracking mode, wherein the monitoring and tracking mode activates the alert system when the device exceeds a threshold speed for a threshold time period, when the device enters a geographically defined exclusion zone during a defined exclusion time, when the device strays from a geographically defined inclusion zone during a defined inclusion time, or a combination of thereof, and the alert system notifies a receiver other than the emergency receiver.

11. The device of claim 10, wherein the electronic operating system activates the wireless telephone communicator to transmit sound over the wireless telephone communicator to the receiver other than the emergency receiver, such that the receiver other than the emergency receiver can hear sound in the vicinity of the device.

12. The device of claim 11, wherein the electronic operating system activates the GPS receiver and transmits the location of the device to the receiver other than the emergency receiver.

13. The device of claim 1, wherein the wireless telephone communicator or the electronic operating system is capable of accessing a plurality of telephone numbers stored in a digital storage medium for connecting the wireless telephone communicator with one or more of the plurality of telephone numbers.

14. The device of claim 13, wherein the wireless telephone communicator or the electronic operating system are coupled to a user interface capable of selecting one or more of the plurality of telephone numbers.

15. The device of claim 1, further comprising a digital storage medium and the GPS receiver is capable of storing data to the digital storage medium.

16. The device of claim 15, wherein data stored by the GPS receiver includes a location of the device as determined by the GPS receiver.

17. The device of claim 16, wherein the data storage medium is capable of storing a plurality of locations of the device as determined by the GPS receiver, and the electronic operating system controls the storing of data using the digital storage medium.

18. The device of claim 1, further comprising a temperature sensor operably coupled to the electronic operating system.

19. The device of claim 1, further comprising a smoke sensor operably coupled to the electronic operating system.

20. The device of claim 1, further comprising a shock sensor operably coupled to the electronic operating system.

21. The device of claim 1, further comprising a panic alarm, wherein the panic alarm is coupled with the electronic operating system.

22. The device of claim 21, wherein the electronic operating system trips the panic alarm, emitting an audible sound, only when an authorized agent activates the panic alarm.

23. The device of claim 1, further comprising an immersion sensor coupled with the electronic operating system.

24. The device of claim 1, wherein the alert system of the device is capable of interfacing with the Amber alert system such that the Amber alert system is capable of notifying the public in the vicinity of the device.

25. The device of claim 1, further comprising an anti-cutting reinforcement.

26. The device of claim 25, wherein the anti-cutting reinforcement includes titanium strands or a titanium cable.

27. The device of claim 25, wherein the anti-cutting reinforcement includes steel strands spun around a core of aramid fibers.

28. The device of claim 25, wherein the anti-cutting reinforcement includes a trip sensor line that notifies the electronic operating system of an open circuit if the trip sensor line is cut.

29. The device of claim 28, wherein the line includes at least one electrically conductive wire.

30. The device of claim 28, wherein the line includes at least one optical fiber.

31. The device of claim 1, further comprising an accelerometer coupled to the electronic operating system.

33. The device of claim 32, wherein the accelerometer is monitored by the electronic operating system and the electronic operating system determines if the device is motionless for a threshold time period for tripping a fault alert.

34. The device of claim 33, wherein the fault alert commences a fault detection system by the electronic operating system to determine if the device is malfunctioning or has been removed from the person.

35. A system for monitoring, tracking and locating a child using the device of claim 1, comprising:
a computer capable of being wirelessly coupled to the device of claim 1, the computer system including a data storage device, a display and an input device; and
a program stored in the data storage device, wherein the program is capable of monitoring, tracking and locating the child.

36. The system of claim 35, wherein the program is capable of graphically displaying the location of the device of claim 1.

37. The system of claim 36, wherein the program is capable of receiving input from the input device to register temporal exclusion and inclusion zones with the device of claim 1.

38. The system of claim 37, wherein the program, the input device and the display are integrated into a graphical user interface of the computer, and the program is capable of displaying a map on the display and the input device is capable of selecting temporal exclusion and inclusion zones.

39. The system of claim 38, wherein the program is capable of registering a threshold speed with the device of claim 1, such that the system is notified by the device of claim 1, when the device of claim 1 exceeds the threshold speed.

40. The system of claim 35, wherein the computer is alerted by the device of claim 1, when the alert system of the device of claim 1 is activated.

41. The system of claim 40, wherein the system alerts a receiver, when the alert system of the device of claim 1 is activated.

42. The system of claim 41, wherein an emergency response system is automatically alerted, when the alert system enters a panic mode.
